(19) United States
(12) Patent Application Publication
(10) Pub. No.: US 2022/0156922 A1
(43) Pub. Date: May 19, 2022

(54) SYSTEM FOR REAL-TIME AUTOMATIC QUANTITATIVE EVALUATION, ASSESSMENT AND/OR RANKING OF INDIVIDUAL SPERM, AIMED FOR INTRACYTOPLASMIC SPERM INJECTION (ICSI), AND OTHER FERTILIZATION PROCEDURES, ALLOWING THE SELECTION OF A SINGLE SPERM

(71) Applicant: Alejandro Chávez Badiola, San Francisco, CA (US)

(72) Inventor: Alejandro Chávez Badiola, San Francisco, CA (US)

(21) Appl. No.: 17/246,633

(22) Filed: May 1, 2021

Related U.S. Application Data
(60) Provisional application No. 63/115,019, filed on Nov. 17, 2020.

(51) Int. Cl. G06T 7/00

(52) U.S. Cl. CPC G06T 7/0012; G06T 2207/10056; G06T 2207/30024; G06T 2207/20084; G06T 2207/20081

(57) ABSTRACT

The present invention is providing a system based on artificial vision, and artificial intelligence that is capable of assisting the embryologist to select the best spermatozoa to be injected during an ICSI procedure, requiring the selection of a single sperm. It can identify the best spermatozoa from a sample, in real-time, based on their morphological and motility characteristics which are observed under the microscope at magnifications equal to or above 20×.

Is an automatic analysis of sequences of images produced by a digital camera attached to a microscope in real-time. It uses computer vision algorithms to automatically detect and track each of the sperms present on every image of a video and compute a number of features related to the morphological characteristics and motility parameters. The features of each sperm are processed and then evaluated using a mathematical model which determines the quality of each sperm and ranks them accordingly.

The present application claims priority to the earlier filed provisional application, having Ser. No. 63/115,019 and confirmation number 2457, and hereby incorporates subject matter of the provisional application in its entirety.

### BACKGROUND OF THE INVENTION

Intracytoplasmic sperm injection (ICSI) is a procedure done in an embryology lab during an in vitro fertilization (IVF) treatment in which a single sperm is injected directly into an oocyte to assist the successful fertilization of an oocyte and to generate an embryo. During ICSI, an embryologist selects what he or she determines to be the best sperm to directly inject into the oocyte. Sperm are selected subjectively by evaluating the morphology (shape) and progression (movement) of the spermatozoa (sperm) from a drop of sample. The selected sperm is then aspirated from the sperm sample into a microtool called an ICSI needle. Once the sperm is in the ICSI needle, the embryologist moves it to a media drop containing the oocyte to be fertilized. The egg to be injected is held in place by a holding pipette, which exerts a light suction on the oocyte, allowing the embryologist to place the oocyte in the preferred injection position. The embryologist then aligns the ICSI needle with the sperm with the oocyte. The ICSI needle is pressed into the side of the egg below the polar body. The zona pellucida and the oolemma are punctured and a small part of the ooplasm is aspirated into the needle to break the membrane and inject the sperm into the oocyte. Embryologists typically perform several ICSI procedures in one session depending on the number of mature oocytes that were retrieved during that cycle. ICSI is widely used in fertility clinics and is typically the method of choice even in cases where male infertility is not a factor.

The success rates of ICSI procedures are highly dependent on oocyte and sperm quality. There is published evidence that poor semen parameters result in low blastocyst formation rates after in vitro fertilization, suggesting that spermatozoa can influence human pre-implantation embryo development. There are different strategies available to select the best spermatozoa from a sample. Most of these strategies are designed to achieve the enrichment of the sample in high-quality spermatozoa in the shortest time possible through sperm preparation techniques, which are capable of removing immotile and low-quality spermatozoa. Examples of these techniques include (a) swim-up and its variants which are based on the recovery of motile spermatozoa that migrate toward a cells-free medium usually placed above the sperm sample, and (b) density gradient centrifugation and its variants which are based on the capacity of motile spermatozoa to progress through a gradient of density constituted by colloidal particles during centrifugation. It is important to note that these strategies increase the chances that a given sperm in the processed sample has good quality, however, these do not provide any guidance or assistance on selecting the best sperm to be injected among all those present in the sample.

It has been shown that spermatozoa with adequate spermatogenesis and maturation exhibit binding sites to hyaluronic acid (HA), which is one of the main components of the extracellular matrix surrounding the cumulus-oocyte complex. Therefore, two approaches have been proposed based on the interaction of sperms with HA: (a) picking up spermatozoa that move slowly when swimming in a medium containing HA, and (b) recovering spermatozoa trapped on the surface of HA-coated dishes. The major drawback of these approaches is the requirement of additional components such as the coated dishes which are expensive and may not be available in all IVF clinics. Moreover, there exist studies that question the utility of sperm selection based on HA-binding.

Intracytoplasmic morphologically selected sperm injection (IMSI) is a technique for selecting spermatozoa that are based on motile sperm organellar morphology examination under high magnification (above 600×) which allows the embryologist to discriminate manually spermatozoa lacking vacuoles. However, to achieve such large magnifications, it is necessary to count with special equipment (in addition to the required microscope and manipulators), which may not be available in most clinics. In addition, the technique does not adapt to standard ICSI, but adds an additional step to operate at high magnification.

Some recent approaches are based on the use of microfluidics which is justified on several fundamentals such as the rheotaxis, chemotaxis, and thermotaxis properties of sperms. While the preliminary results of such approaches are encouraging, they also require the use of expensive special microfluidic devices limiting universal acceptance.

### SUMMARY OF THE INVENTION

The present invention advantageously fills the aforementioned deficiencies by providing a system based on artificial vision, and artificial intelligence that is capable of assisting the embryologist to select the best spermatozoa to be injected during an ICSI procedure, and other fertilization procedures requiring the selection of a single sperm.

This invention is able to identify the best spermatozoa from a sample, in real-time, based on their morphological and motility characteristics which are observed under the microscope at magnifications equal to or above 20×.

The invented system performs an automatic analysis of sequences of images produced by a digital camera attached to a microscope in real-time. The system uses computer vision algorithms to automatically detect and track each of the sperms present on every image of a video and compute a number of features related to the morphological characteristics and motility parameters. The features of each sperm are processed and then evaluated using a mathematical model which determines the quality of each sperm and ranks them accordingly.

The result of the ranking is shown to the user in real-time along with a visual indication of which spermatozoa have higher quality in the sample imaged.

In this document, real-time refers to the capability of the system to process individual images from a video stream generated by the camera microscope in less than 500 milliseconds after its acquisition. This capability allows the system to compute and identify the movement patterns of individual spermatozoa with high precision which is crucial to determine its quality. Moreover, this capability allows the user to identify and select the highest ranked spermatozoa almost instantaneously and not requiring a change of existing operating procedures.

The advantage of using the the AI approach is that a successful outcome may be more probable when injecting a top-ranked sperm compared to a sperm which received a low ranking, or a sperm subjectively selected by an embryologist. The rationale of this claim is related to the fact that the proposed system computes motility and morphological characteristics in a deterministic and quantitative way. Also, while the human eye can assess one sperm very well, it has difficulty tracking many spermatozoa simultaneously and keeping track when their pathways intersect. As a result, embryologists dilute sperm preparations in order to have only a few spermatozoa in the visual field. With an AI such a limitation is not necessary as it can inspect the entire visual field in milliseconds and keep track of the spermatozoa even when their pathways intersect. There exist studies that show that spermatozoa morphology and motility problems are associated with DNA damage [1]. DNA damage is believed to negatively affect fertilization of oocytes [2], reduce the quality of the embryo and increase the chance of miscarriage [3].

Moreover, it is well accepted that sperm motility is an essential criterion for determining male fertility potential. One of these motility parameters is the rotational motion of sperm (RMS) around their longitudinal axis promotes rheotaxis, which is a mechanism that allows the sperm to navigate to the site of fertilization [4]. The RMS speed may be used to distinguish between normal and abnormal sperm cells [5], which could be used in combination with other features to generate an index that can be employed to assess the quality of individual sperm. Note that, for an embryologist it would be difficult to distinguish morphology and motility features that can determine whether fertilization can be achieved or not as spermatozoa are often poorly visualized in samples during ICSI. Also oocytes must be injected swiftly as they have to be kept outside incubators during the procedure.

The proposed invention can be integrated with existing equipment found in most IVF laboratories and does not require other assets such as special chemical compounds, microfluidic devices, or custom-designed Petri dishes. Its design allows for the incorporation and use of mixed realities (e.g. augmented reality, and artificial reality), to accommodate individual preferences and available technologies.

Along with the real-time sperm selection assistant, the system generates a report of the spermatozoa evaluated, which is stored as a file in a readable format.

The proposed invention can be used for developing applications aimed at training and quality assurange and control purposes. For example, a number of videos of sperm samples previously analyzed with the proposed system can be presented to a user on a web page, mobile phone, tablet, or PC app, to select the best sperm for injection without knowing the quality scores determined by the spermatozoa in the videos. Such proficiency scores can be used to determine how well a user is performing sperm selection.

The present invention now will be described more fully hereinafter regarding the accompanying drawings, which are intended to be read in conjunction with this summary, the detailed description, and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete, and will fully convey the full scope of the invention to those skilled in the art.

### DESCRIPTION OF THE FIGURES

FIG. 1. This diagram represents the system for real-time automatic quantitative evaluation, assessment and/or ranking of individual sperm, aimed at optimizing intracytoplasmic sperm injection (ICSI), and other fertilization procedures, requiring the selection of a single sperm.

FIG. 2. It is a representation of equipment (camera and microscope) that generates the images of the system for real-time automatic quantitative evaluation, assessment and/or ranking of individual sperm, aimed at optimizing intracytoplasmic sperm injection (ICSI), and other fertilization procedures, requiring the selection of a single sperm.

FIG. 3. Procedure I is a representation of the semantic segmentation of the spermatozoa in the video sequence.

FIG. 4. Procedure I is a representation of the semantic segmentation of the spermatozoa in the video sequence using a neural network architecture.

FIG. 5. Procedure II is a representation of the process to verify the correspondence of the identity of a sperm within successive frames.

FIG. 6. Represents a diagram with examples of the inputs and outputs for each step of procedure II.

FIG. 7. Depicts a diagram with examples of the inputs and outputs for each step of procedure III.

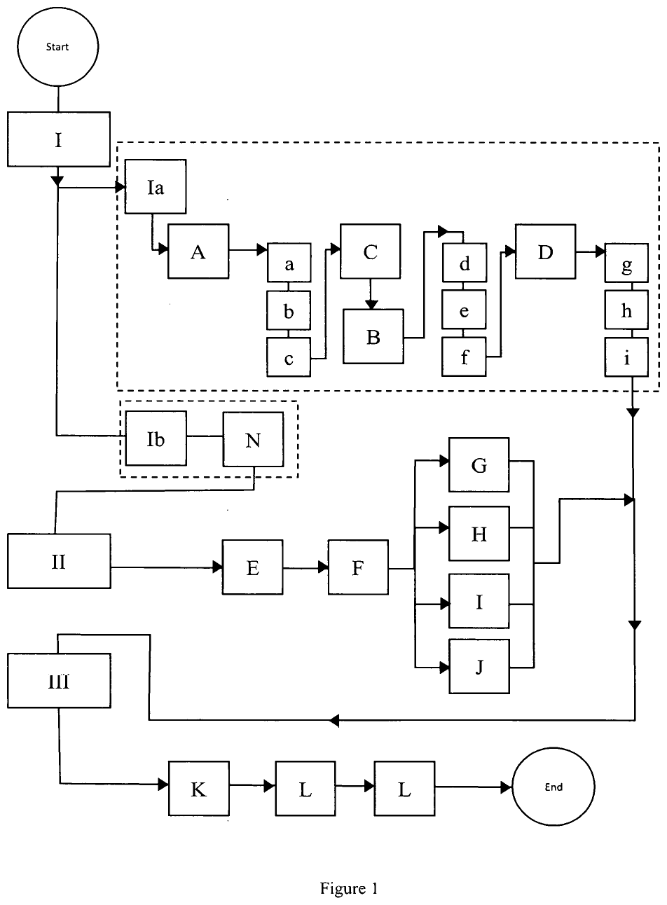

### DESCRIPTION (DESCRIPTION OF THE INVENTION)

According to the previous figures, the system for real-time automatic quantitative evaluation, assessment and/or ranking of individual sperm, aimed for intracytoplasmic sperm injection (ICSI), and other fertilization procedures, allowing the selection of a single sperm, requisites a conventional sample preparation that consists in following sperm collection and regardless of the production method (e.g. masturbation, prostate massage, surgical extraction) usually the following steps are followed before selecting sperm for ICSI:
a. The semen sample is prepared using standard sperm capacitation techniques including centrifuge and swim-up, gradients, or microfluidics (WHO manual REF) This step is usually skipped when sperm is present at low concentrations without the presence of seminal plasma, as is the case when spermatozoa have been surgically retrieved.
b. For manipulation, the spermatozoa are placed in specialized culture media. As an example, one common preparation employs a 10 μL droplet with the multi-purpose handling medium (MHM) solution.
c. A commonly employed step involves the transfer of several spermatozoa aspirated from the previous preparation, and released into a new drop with a specialized solution aimed at reducing sperm motility. One commonly used media for such purpose is a Polyvinylpyrrolidone (PVP) Solution with, or without HSA (Human Serum Albumin)
d. Other methods could be added as part of the sperm preparation and selection process. These may include although are not limited to the use of hyaluronic-acid binding, magnetic-activated cell sorting (MACS), microfluidics, and surface charge Zeta potential.

The above-mentioned preparation steps are not compulsory and when applied, these could be used as standalone steps, or in combination with other steps not included in this description. Sperm preparation protocols may vary by individual laboratory protocols.

Once the sample has been prepared following what has been described, the system for real-time automatic quantitative evaluation, assessment and/or ranking of individual sperm, aimed at ICSI or other fertilization procedures, requires the selection of a single sperm, and comprises the stages of:
I. Location of sperm in images. Which can comprise two different image inputs:
   1a. Image processing by digital filters;
   1b. Image processing by convolutional neural networks;
II. Characterization of sperm patterns; Y
III. Evaluation of the quality of the sperm and the generation of the recommendation of the best sperm to inject.

Where to start the previous process, it is required to prepare the sample before taking images to be processed in the microscope.

### DESCRIPTION OF THE ILLUSTRATED EMBODIMENTS

The invented system takes as an input sequence of images or frames.

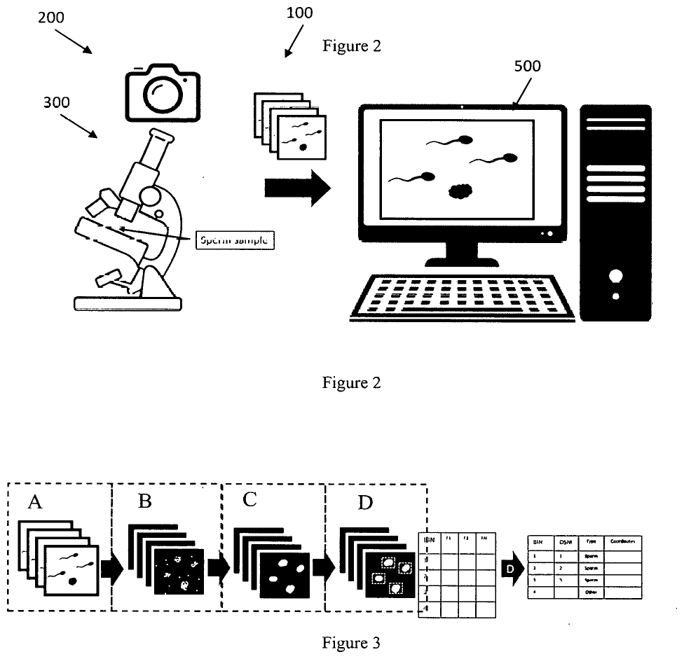

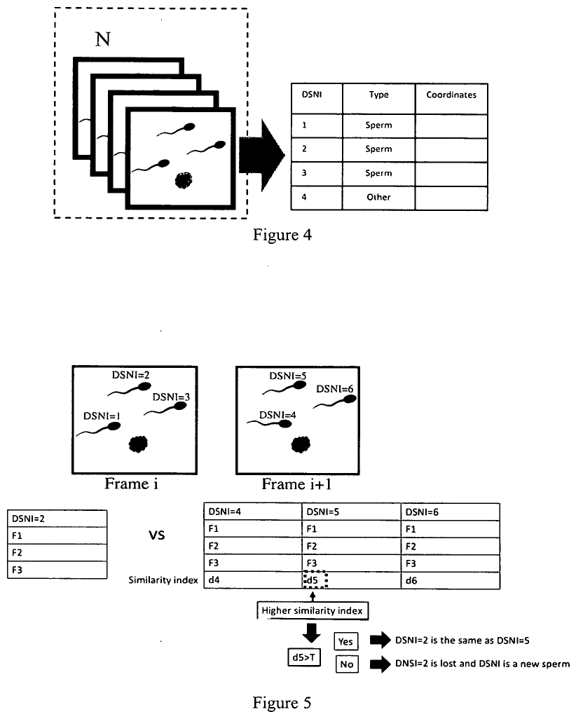

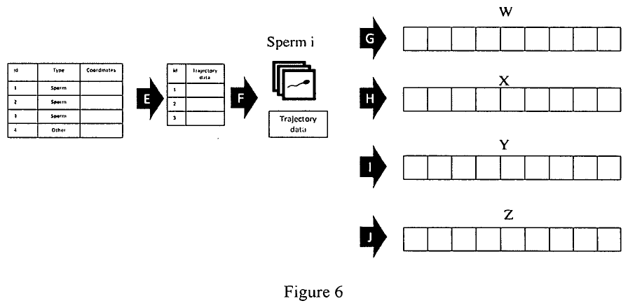

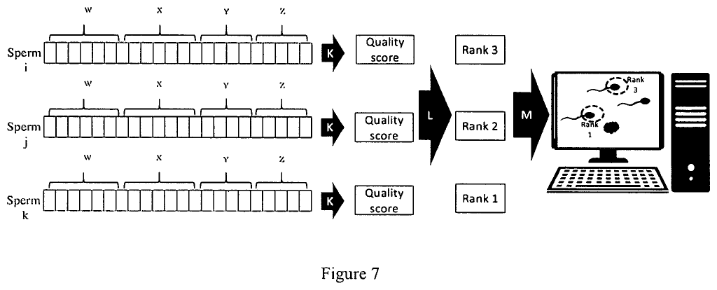

These images 100 may come from a conventional digital camera 200, or an image digitizer that is attached to a camera on the microscope 300 where the spermatozoa sample is being observed or given to the system as a video file (FIG. 2).

The system for real-time automatic quantitative evaluation, assessment and/or ranking of individual sperm, aimed at ICSI, and other fertilization procedures, requiring the selection of a single sperm comprises three parts:

STAGE I. LOCATION OF SPERM IN IMAGES. Once at least two images 100 have been obtained, they can be processed in either of the following two ways:
Ia. IMAGE PROCESSING BY DIGITAL FILTERS.

At this stage each of the images 100 consist of an array of pixels of size n x m, that represents the image that is being observer by the microscope at a given instant; in each pair of arrays 101 and 102, the first array 101 is compared with the second 102, establishing the differences in the intensity values of each pixel; this difference allows establishing a parameter that is compared with a predefined value that determines the if the changes between the first arrangement 101 and the other 102 are significant and therefore are evidence of a possible movement of an element in the microscope. Then it is necessary to discriminate from those movements that are real or not, in such a way that if the difference is only presented in one pixel, then it is digital noise and in case the movement is of a set in neighborhood of changes, then it is a real movement; the real movements are represented in a third arrangement 103 whose inputs are a set of movement records R1, this process is repeated with the total set of images 100, in such a way that all R1 are registered as a set of indicators, among that are, dimension, area, eccentricity, height, width, convexity, and so on; in such a way that these indicators are compared with pre-established patterns to determine their nature, among which they can be characterized as spermatozoa, manipulation pipette, epithelial cells just to mention some and only those that represent spermatozoa that are associated with their indicators are selected in register R2, in such a way that these registers R2 are provided to the next stage;
Ib. IMAGE PROCESSING BY CONVOLUTIONAL NEURAL NETWORKS.

The images 100 are provided to a convolutional neural network N, which is located in a conventional logical processing unit 104 where a mathematical algorithm is housed that allows the association of specific indicators among which are dimension, area, eccentricity, height, width, convexity, among others; in such a way that these indicators are compared with pre-established patterns to determine their nature, in which they can be characterized as spermatozoa, manipulation pipette, epithelial cells just to mention some and only those that represent spermatozoa that are associated with their indicators are selected in register R2, in such a way that these registers R2 have a unique identification number D1 and are provided to the next stage;

STAGE II. CHARACTERIZATION OF SPERM PATTERNS.

In this stage, we seek to identify the trajectory of each sperm and characterize it to turn it into indicators, at least of, trajectory, morphological characteristics such as the head, tail, head movement patterns, tail movement patterns and comprise:

The R2 records of STAGE II are compared (which may be through conventional arithmetic operations) in such a way as to allow establishing a correspondence relationship between the parameters associated with each sperm in such a way that if the correspondence is significant, the T1 trajectory is established by means of coordinates of a Cartesian plane, associated with each register R2, therefore establishing a sequence of coordinates S1 which are translated as a geometric trajectory; but if the correspondence is not significant through the unique record of each sperm, it allows defining whether it is a sperm that enters the visual field of microscope 300 or that it is one of those that were previously in said visual field; in such a way that now each record R1 is associated with a trajectory T1, since each of these could be present and associated with different records R1 which are discriminated by the identifier D1; With these associations of R1+D1+T1, a digital representation 400 is generated for each sperm in the logical processing unit 104, and they are provided to different subprocess:
a) Sub-process for generating descriptors of trajectory patterns W, in each R1+D1+T1 association of each sperm, allows generating at least one indicator such as speed, trajectory, linearity, curvature;
b) Sub-process for the generation of movement pattern descriptors X, in each digital representation 400 of each sperm, it allows generating at least one indicator of head movement, tail movement;
c) Sub-process for characterization of the morphology of the sperm Y, in each digital representation 400 of each sperm, it allows to characterize it at least one indicator of the head shape, tail size, presence of anomalies;
d) Sub-process for characterization of the Z texture, using at least one set of Laws masks, allows to characterize the sperm by their textures;

All these records have uniquely characterized each sperm since R1+D1+T1 is associated with at least their descriptors of trajectory patterns W, descriptors of movement patterns X, characterization of the morphology of the sperm Y, and texture Z, generating a digital arrangement P that represents the input of the next stage of the process;

STAGE III. QUALITY ASSESSMENT OF SPERM AND GENERATION OF RECOMMENDATION OF BEST SPERM TO INJECT.

In this stage, the aim is to relate the indicators generated in STAGE II with a quality index for each analyzed sperm, which allows defining a recommended order for the selection of the sperm to be injected, which is presented on screen 500 of the computer in where the analysis is performed.

The digital context P that identifies each sperm is provided to a mathematical algorithm that determines a Q index for each sperm, which represents the quality of the sperm. The values of the Q indices of all the spermatozoa analyzed are ordered to generate an R list preferably from highest to lowest, in such a way that the first elements of the list correspond to the highest quality spermatozoa to provide a live product of the pregnancy. Finally, a set of sperm is identified (preferably at least three) with the Q index values that appear in the list (those with the highest indices) and a digital indicator is generated for each of the sperm according to its register R2 and S1 corresponding, which is superimposed on the most recently acquired image of 100 and displayed on the screen 500 of the computer where the analysis is carried out.

Therefore, when a user asks the system for assistance in the selection of the best sperms to inject during an ICSI procedure, the system perform: K. the calculation of a quality metric of each sperm; L the computation of a ranking of the quality of the detected sperms; and M. the denotation to the user of the best-ranked sperms.

The calculation of a quality metric of each sperm (process K) consists of assigning a numeric value to each sperm by evaluating the sets W, X, Y, and Z using a mathematical model that can be generated by an expert or by the use of machine learning or artificial intelligence algorithms included but not limited to neural networks, linear classifiers, probabilistic classifiers, trees, logistic regression, clustering methods, and deep learning classifiers.

The computation of a ranking of the quality of the detected sperms (process L) consists of sorting the sperms according to the quality metric generated in step K.

The denotation to the user of the best-ranked spermatozoa (M) consists of according to the measurements and the ranking, overlaying graphic elements on the locations of the selected spermatozoa on each frame of the real-time video stream and displaying them to the user of the invented system by using 500. Examples of 500 include a computer screen, mobile phone, tablet, or with a virtual or augmented reality headset or lenses.

III. Evaluation of the quality spermatozoa and generation of the recommendation of the best sperm to be injected.

Where:

STAGE I. LOCATION OF SPERM IN IMAGES. Once at least two images 100 have been obtained, they can be processed in either of the following two ways:
Ia. IMAGE PROCESSING BY DIGITAL FILTERS.

At this stage each of the images 100 consist of an array of pixels of size n x m, that represents the image that is being observer by the microscope at a given instant; in each pair of arrays 101 and 102, the first array 101 is compared with the second 102, establishing the differences in the intensity values of each pixel; this difference allows establishing a parameter that is compared with a predefined value that determines the if the changes between the first arrangement 101 and the other 102 are significand and therefore are evidence of a possible movement of an element in the microscope. Then it is necessary to discriminate from those movements that are real and not, in such a way that if the difference is only presented in one pixel, then it is digital noise and in case the movement is of a set in neighborhood of changes, then it is a real movement; the real movements are represented in a third arrangement 103 whose inputs are a set of movement records R1, this process is repeated with the total set of images 100, in such a way that all R1 are registered as a set of indicators, among that are, dimension, area, eccentricity, height, width, convexity, and so on; in such a way that these indicators are compared with pre-established patterns to determine their nature, among which they can be characterized as spermatozoa, manipulation pipette, epithelial cells just to mention some and only those that represent spermatozoa that are associated with their indicators are selected in register R2, in such a way that these registers R2 are provided to the next stage;
Ib. IMAGE PROCESSING BY CONVOLUTIONAL NEURAL NETWORKS.

The images 100 are provided to a convolutional neural network N, which is located in a conventional logical processing unit 104 where a mathematical algorithm is housed that allows the association of specific indicators among which are dimension, area, eccentricity, height, width, convexity, among others; in such a way that these indicators are compared with pre-established patterns to determine their nature, in which they can be characterized as spermatozoa, manipulation pipette, epithelial cells just to mention some and only those that represent spermatozoa that are associated with their indicators are selected in register R2, in such a way that these registers R2 have a unique identification number D1 and are provided to the next stage;

STAGE II. CHARACTERIZATION OF SPERM PATTERNS.

In this stage, we seek to identify the trajectory of each sperm and characterize it to turn it into indicators, at least of, trajectory, morphological characteristics such as the head, tail, head movement patterns, tail movement patterns and comprise:

The R2 records of STAGE II are compared (which may be through conventional arithmetic operations) in such a way as to allow establishing a correspondence relationship between the parameters associated with each sperm in such a way that if the correspondence is significant, the T1 trajectory is established by means of coordinates of a Cartesian plane, associated with each register R2, therefore establishing a sequence of coordinates S1 which are translated as a geometric trajectory; but if the correspondence is not significant through the unique record of each sperm, it allows defining whether it is a sperm that enters the visual field of microscope 300 or that it is one of those that were previously in said visual field; in such a way that now each record R1 is associated with a trajectory T1, since each of these could be present and associated with different records R1 which are discriminated by the identifier D1; With these associations of R1+D1+T1, a digital representation 400 is generated for each sperm in the logical processing unit 104, and they are provided to different subprocess:
a) Sub-process for generating descriptors of trajectory patterns W, in each R1+D1+T1 association of each sperm, allows generating at least one indicator such as speed, trajectory, linearity, curvature;
b) Sub-process for the generation of movement pattern descriptors X, in each digital representation 400 of each sperm, it allows generating at least one indicator of head movement, tail movement;
c) Sub-process for characterization of the morphology of the sperm Y, in each digital representation 400 of each sperm, it allows to characterize it at least one indicator of the head shape, tail size, presence of anomalies;
d) Sub-process for characterization of the Z texture, using at least one set of Laws masks, allows to characterize the sperm by their textures;

All these records have uniquely characterized each sperm since R1+D1+T1 is associated with at least their descriptors of trajectory patterns W, descriptors of movement patterns X, characterization of the morphology of the sperm Y, and texture Z, generating a digital arrangement P that represents the input of the next stage of the process;

STAGE III. QUALITY ASSESSMENT OF SPERM AND GENERATION OF RECOMMENDATION OF BEST SPERM TO INJECT

In this stage, the aim is to relate the indicators generated in STAGE III with a quality index for each analyzed sperm, which allows defining a recommended order for the selection of the sperm to be injected, which is presented on screen 500 of the computer in where the analysis is performed.

The digital context P that identifies each sperm is provided to a mathematical algorithm that determines a Q index for each sperm, which represents the quality of the sperm. The values of the Q indices of all the spermatozoa analyzed are ordered to generate an R list preferably from highest to lowest, in such a way that the first elements of the list correspond to the highest quality spermatozoa to provide a live product of the pregnancy. Finally, a set of sperm is identified (preferably at least three) with the Q index values that appear in the list (those with the highest indices) and a digital indicator is generated for each of the sperm according to its register R2 and S1 corresponding, which is superimposed on the most recently acquired image of 100 and displayed on the screen 500 of the computer where the analysis is carried out.

Therefore, when a user asks the system for assistance in the selection of the best sperm to inject during an ICSI procedure the system performs: K. the calculation of a quality metric of each sperm; L the computation of a ranking of the quality of the detected sperms; and M. the denotation to the user of the best-ranked sperms.

The calculation of a quality metric of each sperm (process K) consists of assigning a numeric value to each sperm by evaluating the sets W, X, Y, and Z using a mathematical model that can be generated by an expert or by the use of machine learning or artificial intelligence algorithms included but not limited to neural networks, linear classifiers, probabilistic classifiers, trees, logistic regression, clustering methods, and deep learning classifiers.

The computation of a ranking of the quality of the detected sperm (process L) consists of sorting the sperm according to the quality metric generated in step K.

The denotation to the user of the best-ranked sperm (M) consists of according to the measurements and the ranking, overlaying graphic elements on the locations of the selected sperm on each frame of the real-time video stream and displaying them to the user of the invented system by using 500. Examples of 500 include a computer screen, mobile phone, tablet, or with a virtual or augmented reality headset or lenses.

The invention claimed is:

1. A system for the evaluation, assessment, and/or automatic quantitative classification in real-time of individual sperm, intended for intracytoplasmic sperm injection (ICSI) and other fertilization procedures, requiring the selection of a single sperm to implement a method to select a sperm comprising:
i. An apparatus for obtaining images, which may be a camera or a microscope, whose images obtained from a previously prepared sample is provided to
ii. a logical processing unit where
iii. a mathematical algorithm based on artificial intelligence, such as convolutional neural networks or algorithms type machine learning which assigns a set of indicators to each sperm allowing to establish a ranking among them in order to
iv. select and separate that sperm that results with the optimal indicators to achieve a successful fertilization.
v. select and separate that sperm that results with the optimal indicators to achieve a successful development to the blastocyst stage.
vi. select and separate that sperm that results with the optimal indicators to achieve a successful pregnancy.

2. A method to assign in real-time automatic quantitative evaluation, assessment and/or ranking of individual sperm, aimed at intracytoplasmic sperm injection (ICSI), and other fertilization procedures, requiring the selection of a single sperm that comprises the stages of:
I. Location of sperm in images. Which can comprise two different image inputs:
1a. Image processing by digital filters.
1b. Image processing by convolutional neural networks.
II. Characterization of sperm patterns; and
